(19) United States
(12) Patent Application Publication
(10) Pub. No.: US 2014/0324498 A1
(43) Pub. Date: Oct. 30, 2014

(54) RISK-LIMITED DISPATCH OF KNOWLEDGE WORK

(71) Applicant: International Business Machines Corporation, Armonk, NY (US)

(72) Inventors: Shivali Agarwal, Ghaziabad (IN); Yi-Min Chee, Yorktown Heights, NY (US); Juhnyoung Lee, Yorktown Heights, NY (US); Renuka R. Sindhgatta, Bangalore (IN); Lav R. Varshney, Yorktown Heights, NY (US)

(73) Assignee: International Business Machines Corporation, Armonk, NY (US)

(21) Appl. No.: 14/029,012

(22) Filed: Sep. 17, 2013

Related U.S. Application Data
(63) Continuation of application No. 13/870,422, filed on Apr. 25, 2013.

(51) Int. Cl. G06Q 10/06

(52) U.S. Cl. CPC G06Q 10/0635
USPC 705/7.15

(57) ABSTRACT

A real-time monitoring sub-system may monitor resources, work requests, and work progress in an on-going manner in information technology global service delivery provisioning. An integrated management and planning subsystem may simultaneously operate on a plurality of timescales to optimize a service delivery objective under a constraint of schedule risk. The integrated management and planning subsystem may continuously update a work plan based on solving in the on-going manner, the optimized service delivery objective using the monitored resources, work requests and work progress.

### CROSS-REFERENCE TO RELATED APPLICATIONS

This application is a continuation of U.S. Ser. No. 13/870,422, filed on Apr. 25, 2013, the entire content and disclosure of which is incorporated herein by reference.

### FIELD

The present application relates generally to computers, and computer applications, and more particularly to risk-limited dispatch of knowledge work in global service delivery.

### BACKGROUND

A global service delivery model is a model of knowledge work used by companies engaged in information technology (IT) consulting and services delivery to execute a technology project using globally distributed resources. A global service delivery involves and considers technical skills, process rigor, tools, methodologies, overall structure and strategies in delivering technology services from global locations. Via such global service delivery, companies that deliver services are better able to meet customer requirements, for example, via understanding of local language and culture and service delivery work around the clock.

Large-scale systems for global service delivery are complex and have a multitude of sources of uncertainty and yet must dispatch work to resources to meet stringent cost, schedule, and quality requirements. Management, planning, and work assignment for global service delivery happens on several timescales. Current methods of managing, planning, and assigning work tasks to knowledge workers does not explicitly consider the risk associated with the several sources of uncertainty and are therefore unable to incorporate optimization that limits risks due to stochastic uncertainty.

### BRIEF SUMMARY

A system for performing risk-limited dispatch of knowledge work, in one aspect, may comprise a real-time monitoring sub-system operable to execute on a processor and further operable to monitor resources, work requests, and work progress in an on-going manner in information technology global service delivery provisioning. An integrated management and planning subsystem may be operable to execute on the processor and further operable to simultaneously operate on a plurality of timescales to optimize a service delivery objective under a constraint of schedule risk, the integrated management and planning subsystem continuously updating a work plan based on solving in the on-going manner, the optimized service delivery objective using the monitored resources, work requests and work progress.

A method for performing risk-limited dispatch of knowledge work, in one aspect, may comprise monitoring resources, work requests, and work progress in an on-going manner in global service delivery provisioning. The method may also comprise simultaneously operating on a plurality of timescales to optimize a service delivery objective under a constraint of schedule risk. The method may further comprise continuously updating a work plan based on solving in the on-going manner, the optimized service delivery objective using the monitored resources, work requests and work progress.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE SEVERAL VIEWS OF THE DRAWINGS

FIG. 1 is a diagram illustrating a global service delivery in one embodiment of the present disclosure.

FIG. 2 is a diagram illustrating a multiscale planning subsystem in one embodiment of the present disclosure.

FIG. 3 shows an example output, for example, presented via a graphical user interface that displays the output graphically.

FIG. 4 is a diagram illustrating a method of the present disclosure in one embodiment.

FIG. 5 shows tranches of services of varying levels of reliability in service delivery in one embodiment of the present disclosure.

FIG. 6 illustrates a schematic of an example computer or processing system that may implement the risk-limited dispatch of knowledge work system in one embodiment of the present disclosure.

### DETAILED DESCRIPTION

In one embodiment of the present disclosure, a risk-limiting dispatch methodology in a global service delivery system is provided that uses real-time information about supply and demand obtained from an instrumented/metered work organization and takes into account the stochastic nature of work resources and demand requirements. The methodology provides for a real-time, multiscale, data-driven system for instrumentation, collection, and analysis of data that is used to optimize work allocation under the risk-limiting paradigm. A risk-limit dispatch used in power engineering is extended and applied to global service delivery, for example, to match knowledge workers with multifarious skills to knowledge work tasks that require a variety of skills over a variety of timescales. Knowledge work involves any of the kinds of work that can be done in global delivery such as software development, graphic design, technical document production, etc. Knowledge worker refers to a worker that can perform knowledge work. For instance, risk-limiting dispatch of work to work resources is provided so as to improve resilience and efficiency. A cataloging and contracting mechanism may be also provided for service delivery with degrees of guarantees (e.g., “soft” guarantees).

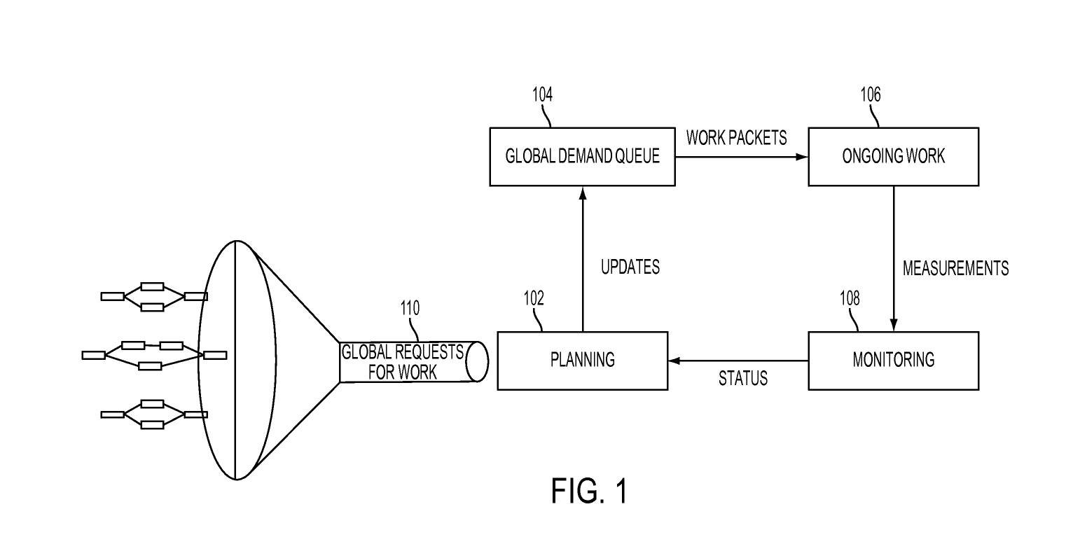

FIG. 1 is a diagram illustrating a global service delivery in one embodiment of the present disclosure. A global delivery model comprising planning subsystem or module 102, global demand queue subsystem or module 104, ongoing work subsystem or module 106 and monitoring subsystem or module 108, that continuously monitors ongoing work related to received global requests for work 110. Over several timescales, a monitoring subsystem 108 continuously measures stochastic perturbations to the planned operation that may include new requests that are made (e.g., 110), changes made to pending request's attributes (e.g., begin-end dates, etc.), and issues or opportunities detected during runtime.

The global delivery model also continuously optimizes for risk-limited dispatch. For example, based on measurements of stochastic perturbations, the planning subsystem 102 continuously optimizes over multiple timescales for risk-limited dispatch of work to the workforce.

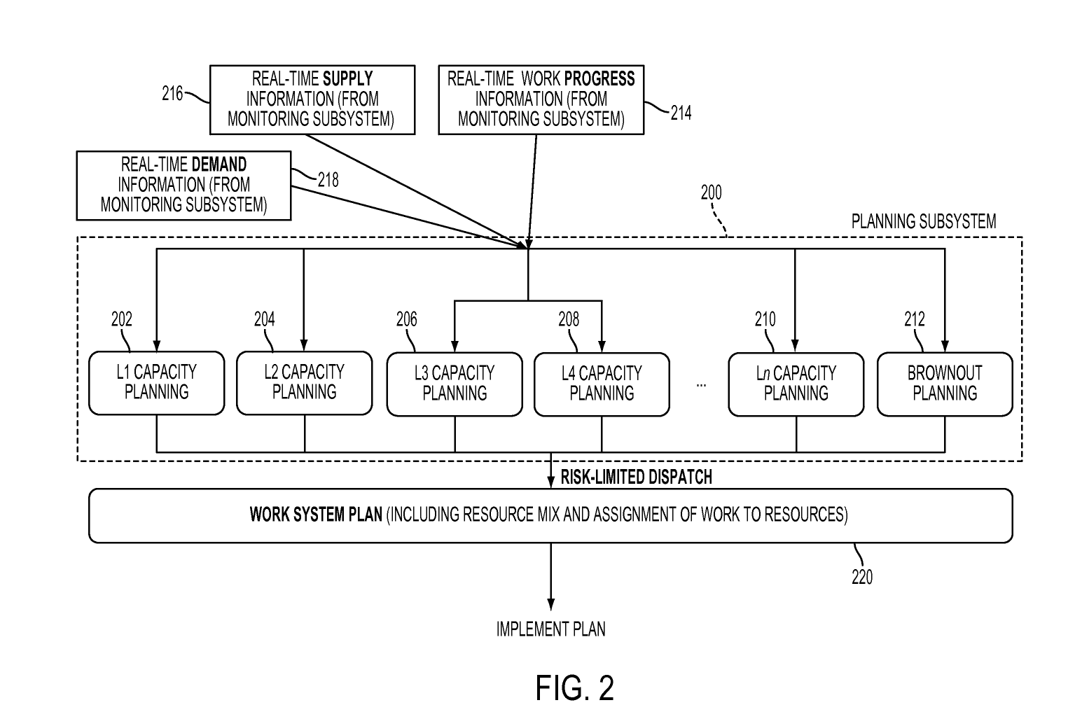

FIG. 2 is a diagram illustrating a multiscale planning subsystem, e.g., shown in FIG. 1 at 102, in one embodiment of the present disclosure. Timescales of planning may include L1 management and planning, L2 management and planning, L3 management and planning, and so forth (208, 210), and Brownout management and planning 212. L1 management and planning 202 may include optimal high-level strategy such as which country to locate a work center in response to labor markets, costs, etc., e.g., on a scale of months/years. L2 management and planning 204 may include optimal hiring plan, e.g., on a scale of weeks/months. L3 management and planning 206 may include optimal assignment of work tasks to workers in response to needs, skills, synergies, and interdependencies, e.g., on a scale of days/hours. Brownout management and planning 212 may include ad hoc rejiggering of work assignments in response to perturbations that cannot be dealt with through replanning, e.g., typically on a scale of minutes. Those management and planning functionalities receive real-time work progress information 214, real-time supply information 216, real-time demand information 218 from the monitoring subsystem (e.g., FIG. 1 at 108).

The following describes a risk-limiting dispatch over all timescales simultaneously. Let p be vector of system parameters such as geography of workforce, resource pool, person-work synergy matrix, work-work synergy matrix, person-person synergy matrix, and work-work interdependency matrix. Let x be vector of state variables such as how long the worker are into their current work tasks and which tasks these are. Let u be vector of control variables such as hiring actions and the assignment matrices of which person is assigned to do which work at the several time intervals into the future. Let F(x, u, p) be an objective function, e.g., total quality of work produced. Let n(p)=D(x, u, p)−S(x, u, p) be severity index, the degree of not meeting delivery schedule constraints, defined in terms of worker supply D and work demand S. Let R(n(p))=Pr[n(p)>0] be the operating risk. The risk-limiting dispatch problem is formulated as max F(x, u, p), such that (s.t.) R(n(p))<=ρ·ρ(rho) represents an exogenous parameter that specifies how reliable the delivery needs to be. It specifies the upper bound on the operating risk. F is the objective function to be optimized, n determines the constraint that must be met associated p. R(n(p)) may be predefined and represents the probability that the severity index is positive. Given the objective function with constraints, the decision variable u in the optimization is solved for.

Central global service delivery planner 200 (or a distributed system that can implement control) receives metrics readings yₜ from a monitoring subsystem at time t and assesses R(n(p)|yₜ), and dynamically optimize the decision variables, e.g., L1 decision (e.g., start a work center in X location next year); L2 decision (e.g., hire Y number of programmers next month); L3 decision (e.g., assign task A to worker B to start tomorrow); Brownout decision (e.g., reassign task C from worker B to worker D since worker B just had to go home due to illness). Those decisions along with random events determine actual work resources available S and delivered D at time t.

A solution to the multiscale optimization problem max F(x, u, p), such that (s.t.) R(n(p))<=ρ can be solved in a computer-implemented system. For example, an iLOG (from International Business Corporation, Armonk, N.Y.) implementation of a constraint-based optimization algorithm for multi-stage stochastic decision problems may be used.

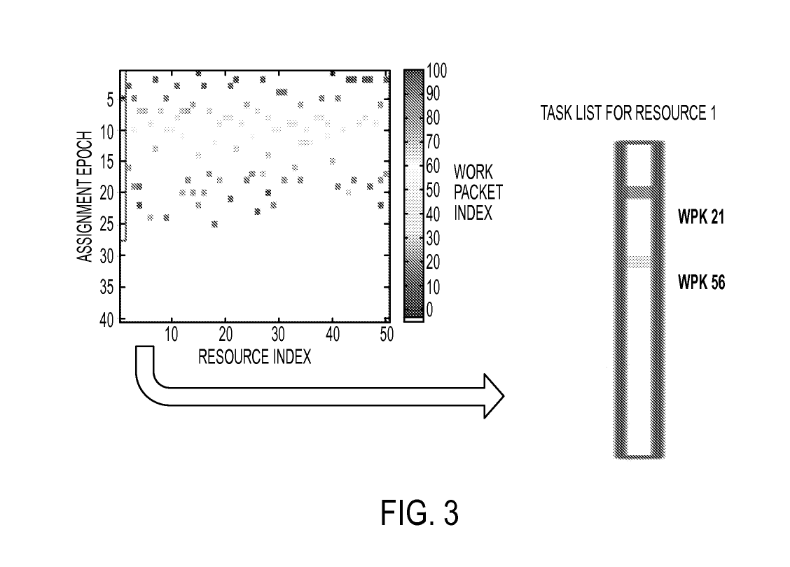

Work system plan 220 includes the continuously updated “palimpsestic” output of the planning subsystem 220 and has actions associated with each timescale of planning. An example output of the optimization algorithm that performs risk-limited dispatch, depicted at the L3 timescale is an assignment of which worker should do which work in which order (or at what time). FIG. 3 shows an example output, for example, presented via a graphical user interface that displays the output graphically, for example, with color gradients to denote different workers and different assignments.

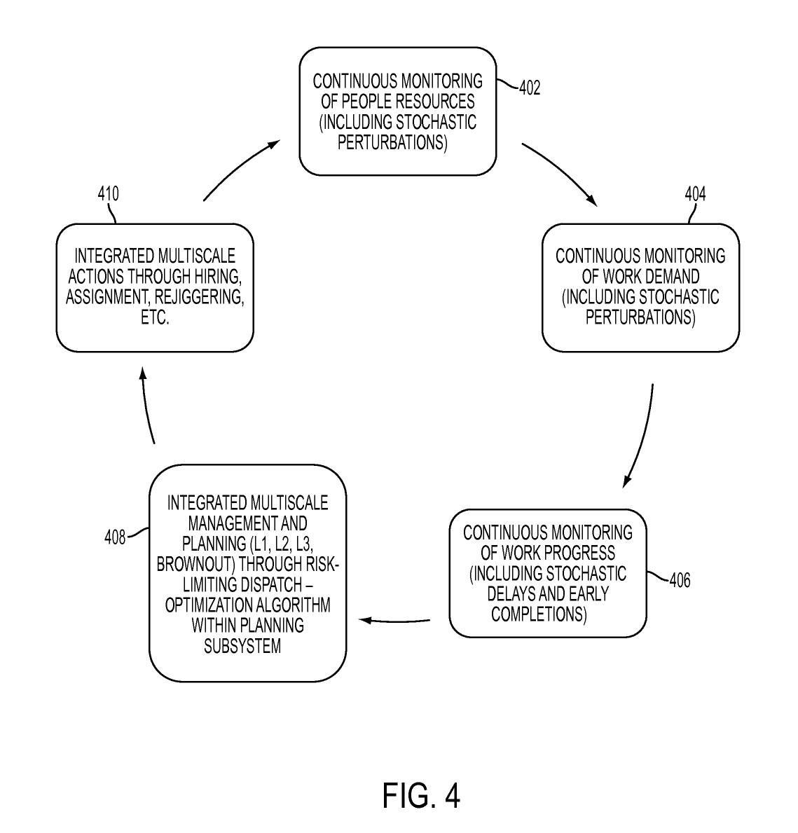

FIG. 4 is a diagram illustrating a method of the present disclosure in one embodiment. The methodology includes processes operating continuously over the several timescales in an integrated fashion. Examples of the various timescales may include minute-by minute monitoring of worker availability, hour-by-hour monitoring of work to be done, and month-by-month monitoring of work locations established globally. For instance, at 402, continuous monitoring of people resources (including stochastic perturbations) is performed. At 404, continuous monitoring of work demand (including stochastic perturbations) is performed. At 406, continuous monitoring of work progress (including stochastic delays and early completions) is performed. At 408, integrated multiscale management and planning (e.g., L1, L2, L3, brownout) through risk-limiting dispatch (optimization algorithm within planning subsystem) is performed. The timescales (e.g., the levels of minutes, days, months, etc.) may be determined by the timescale of the actions that can be taken, and may be configurable. At 410, integrated multiscale actions through hiring, assignment, rejiggering (reassignment), etc., may be performed.

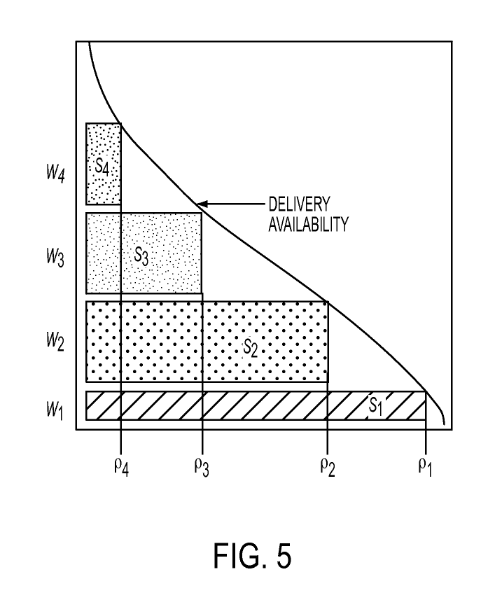

The risk-limited dispatch system may allow for a contracting mechanism for global service delivery with probabilistic schedule guarantees, for example, service contract based on cost and schedule reliability ρ. For example, FIG. 5 shows a “tranche” style of contract, where a buyer may purchasing different kinds of contracts with differing levels of reliability. The “s1,” “s2,” “s3,” “s4” refer to the amount of service of a given level of reliability “rho_1,” “rho_2,” “rho_3,” “rho_4,” that a requestor of work contracts for. The “w1,” “w2,” “w3,” “w4” represent the total work items of each type that are contracted for. Service provider may provide contracts for different levels of service reliability based on stochastic characterization of system, with differing costs. Service requestor may purchase “tranches” or bundles of service delivery contracts with a variety of levels of reliability, so as to optimize the tradeoff between cost and schedule reliability. Contracts can be made dynamic in nature where the service provider can provide swing option for a new request from the client.

For providing a catalog to support the market, several service offerings can be listed in a catalog with varying prices corresponding to varying probabilistic schedule guarantees. Historical information may be used to provide price based schedule guarantees. For instance, the severity index for different service offerings executed by delivery organization/provider may be computed. The probability distribution of the severity index may be used to evaluate the risks related to the service offerings. Differential pricing for schedule guarantees may be provided based on the probability distribution of the service index.

A methodology of the present disclosure in one embodiment performs risk-limited dispatch of knowledge work to resources. A real-time monitoring system is provided for continuously monitoring resources (supply), work requests (demand), and work progress. An integrated management and planning subsystem simultaneously operates on several timescales that optimize a service delivery objective (such as cost and/or quality) under a constraint of schedule risk. A multiscale “palimpsestic” work plan is continuously updated by the planning and management system. One more actions may be taken based on the updated work plan. Examples of actions may include implementing large-scale strategic work/workforce changes, adding more resources, adjusting work assignments, and/or rejiggering work assignments. A catalog for global service delivery with probabilistic schedule guarantees may provide support for a market of contracts for global service delivery with “soft” probabilistic schedule guarantees.

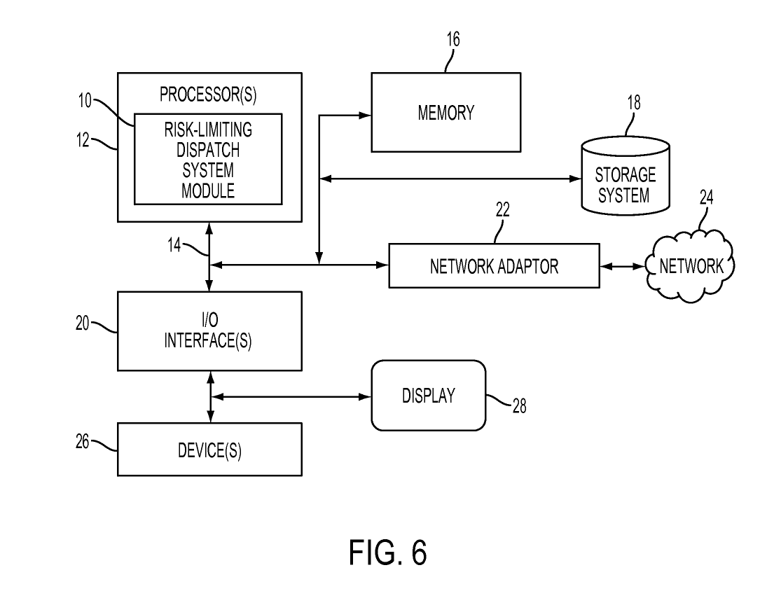

FIG. 6 illustrates a schematic of an example computer or processing system that may implement the risk-limited dispatch of knowledge work system in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 6 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a risk-limiting dispatch module 10 that performs the methods described herein. The module 10 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A system for performing risk-limited dispatch of knowledge work, comprising:
a processor;
a real-time monitoring sub-system operable to execute on the processor and further operable to monitor resources, work requests, and work progress in an on-going manner in information technology global service delivery provisioning; and
an integrated management and planning subsystem operable to execute on the processor and further operable to simultaneously operate on a plurality of timescales to optimize a service delivery objective under a constraint of schedule risk, the integrated management and planning subsystem continuously updating a work plan based on solving in the on-going manner, the optimized service delivery objective using the monitored resources, work requests and work progress.

2. The system of claim 1, further comprising:
a catalog for global service delivery with probabilistic schedule guarantees to support a market of contracts for global service delivery.

3. The system of claim 1, wherein the work plan comprises a strategy for locating a work center.

4. The system of claim 1, wherein the work plan comprises a strategy for managing workers.

5. The system of claim 1, wherein the work plan comprises assignment of work tasks.

6. The system of claim 1, wherein the work plan comprises reassignment of work based on perturbations in a plan.

7. A computer readable storage medium storing a program of instructions executable by a machine to perform a method of performing risk-limited dispatch of knowledge work, comprising:
monitoring resources, work requests, and work progress in an on-going manner in information technology global service delivery provisioning;
simultaneously operating on a plurality of timescales to optimize a service delivery objective under a constraint of schedule risk; and
continuously updating a work plan based on solving in the on-going manner, the optimized service delivery objective using the monitored resources, work requests and work progress.

8. The computer readable storage medium of claim 7, further comprising:
generating a catalog for global service delivery with probabilistic schedule guarantees to support a market of contracts for global service delivery.

9. The computer readable storage medium of claim 7, wherein the work plan comprises a strategy for locating a work center.

10. The computer readable storage medium of claim 7, wherein the work plan comprises a strategy for managing workers.

11. The computer readable storage medium of claim 7, wherein the work plan comprises assignment of work tasks.

12. The computer readable storage medium of claim 7, wherein the work plan comprises reassignment of work based on perturbations in a plan.
